(19) United States
(12) Patent Application Publication
(10) Pub. No.: US 2018/0007583 A1
(43) Pub. Date: Jan. 4, 2018

(54) Methods And Devices For Establishing Radio Resource Control (RRC) Connection

(71) Applicant: Beijing Xiaomi Mobile Software Co., Ltd., Beijing (CN)

(72) Inventors: Wei HONG, Beijing (CN); Li WANG, Beijing (CN); Ming ZHANG, Beijing (CN)

(73) Assignee: Beijing Xiaomi Mobile Software Co., Ltd., Beijing (CN)

(21) Appl. No.: 15/631,586

(22) Filed: Jun. 23, 2017

Related U.S. Application Data
(63) Continuation of application No. PCT/CN2016/087907, filed on Jun. 30, 2016.

(51) Int. Cl. H04W 28/06; H04W 92/02; H04W 76/02; H04W 72/04; H04L 12/801; H04W 92/14; H04B 7/26

(52) U.S. Cl. CPC H04W 28/06; H04W 92/14; H04W 92/02; H04B 7/2656; H04W 72/0446; H04L 47/10; H04W 76/02

(57) ABSTRACT

Method, apparatuses, and storage mediums are provided for establishing an RRC connection in the technical field of communications. The method may include: receiving a designated signaling sent by a first base station, the designated signaling carrying system configuration information of a second base station; and establishing an RRC connection with the second base station, based on the system configuration information of the second base station.

### CROSS-REFERENCE TO RELATED APPLICATION

This application is based on and claims the priority of the PCT application No. PCT/CN2016/087907, filed on Jun. 30, 2016, which is incorporated herein by reference in its entirety.

### TECHNICAL FIELD

The present disclosure is related to the technical field of communications, and more particularly to a Radio Resource Control (RRC) connection establishing method and apparatus, and a storage medium.

### BACKGROUND

With the development of communication technology, mobile communications have made a great leap forward from voice services to mobile broadband data services, which not only greatly changes people's life style but also significantly promotes the development of society and economy. As two major driving forces for the future development of mobile communications, mobile Internet and Internet of Things enable a wide range of applications of the Fifth Generation (5G) technology. Towards 2020 and beyond, data traffic will increase by several thousand times, and connections between hundred billions of devices and diverse service requirements will pose serious challenges to the 5G system design. The 5G technology will satisfy people's very high requirements for traffic density, number of connections and mobility, and can provide users with extreme service experiences such as high fidelity video, virtual reality, augmented reality, cloud desktop and online games. The 5G technology will penetrate into fields such as Internet of Things to be deeply integrated with industrial facilities, medical devices, vehicles and the like, so as to completely realize “Internet of Everything” and effectively satisfy requirements for information services in vertical industries such as industry, medical treatment and transportation. Further, the 5G technology will significantly improve energy and cost efficiency of network construction and operation, promote service innovation capability comprehensively, and enlarge the scope of the mobile communications industry.

### SUMMARY

To address the problem in the related art, the present disclosure provides an RRC connection establishing method and apparatus, and a storage medium.

According to a first aspect, there is provided an RRC connection establishing method, which may be implemented in a first base station. The method may include: generating a designated signaling from system configuration information of a second base station, the designated signaling carrying the system configuration information of the second bases station; and sending the designated signaling to a User Equipment (UE) so that the UE establishes an RRC connection based on the system configuration information of the second base station.

According to a second aspect, there is provided a base station. The base station comprises: a processor; and a memory storing instructions executable by the processor. The processor is configured to: generate a designated signaling from system configuration information of a second base station, the designated signaling carrying the system configuration information of the second bases station; and send the designated signaling to a UE so that the UE establishes an RRC connection based on the system configuration information of the second base station.

According to a third aspect, there is provided a non-transitory computer-readable storage medium having stored therein instructions that, when executed by a processor of a first base station, causes the first base station to perform acts including: generating a designated signaling from system configuration information of a second base station, the designated signaling carrying the system configuration information of the second bases station; and sending the designated signaling to a UE so that the UE establishes an RRC connection based on the system configuration information of the second base station.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 is an architectural diagram of a communication system according to one or more exemplary embodiments;

FIG. 2 is a flowchart of an RRC connection establishing method according to one or more exemplary embodiments;

FIG. 3 is a schematic diagram of a control plane aggregation network architecture according to one or more exemplary embodiments;

FIG. 4 is a schematic diagram of a control plane aggregation network architecture according to one or more exemplary embodiments;

FIG. 5 is a block diagram of a user equipment according to one or more exemplary embodiments;

FIG. 6 is a block diagram of a base station according to one or more exemplary embodiments;

FIG. 7 is a block diagram of a user equipment according to one or more exemplary embodiments;

FIG. 8 is a block diagram of a base station according to one or more exemplary embodiments.

### DETAILED DESCRIPTION

In order to make objects, solutions and advantages of the disclosure more apparent, embodiments of the disclosure will be described below in detail in conjunction with the accompanying drawings.

Reference will now be made in detail to embodiments, examples of which are illustrated in the accompanying drawings. The following description refers to the accompanying drawings in which the same numbers in different drawings represent the same or similar elements unless otherwise indicated. The implementations set forth in the following description of embodiments do not represent all implementations consistent with the disclosure. Instead, they are merely examples of apparatuses and methods consistent with aspects related to the disclosure as recited in the appended claims.

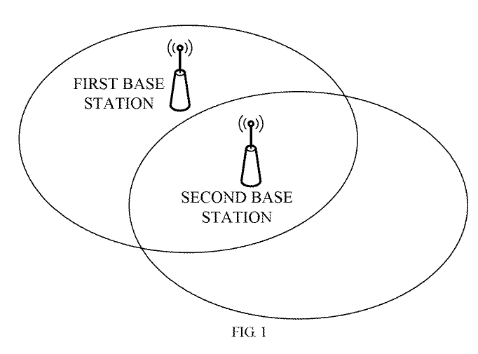

FIG. 1 is an architectural diagram of a communication system according to one or more exemplary embodiments. As shown, the communication system may include a first base station and a second base station. Between the first base station and the second base station, a designated interface may be provided for information interaction therebetween. The first base station and the second base station may utilize different communication protocols. For example, the first base station utilizes a Long-Term Evolution (LTE) protocol and is a base station in an LTE system, while the second base station utilizes a 5G protocol and is a base station in a 5G system. Additionally, the first base station and the second base station may have overlapped coverage areas, which is not limited in the disclosure. Of course, the first base station may be a 5G base station while the second base station may be an LTE base station, which is not limited in the embodiment of the disclosure.

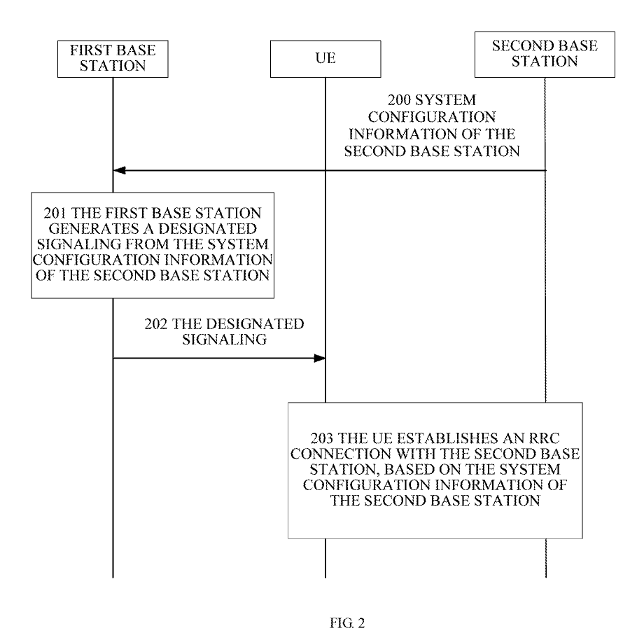

FIG. 2 is a flowchart of an RRC connection establishing method according to one or more exemplary embodiments. As shown, the RRC connection establishing method, which is described by merely taking an example where a UE is currently located in a coverage area of a first base station, comprises the following steps.

At step 201, the first base station generates a designated signaling based on system configuration information of a second base station, the designated signaling carrying the system configuration information of the second base station.

The system configuration information of the second base station is sent to the first base station by the second base station through a designated interface. The designated interface may be an Xn interface, which is an interface for performing communications between base stations. For example, the Xn interface may be between a Master eNB (MeNB) and a secondary eNB (SeNB).

At step 200, the second base station sends the system configuration information of the second base station to the first base station through the designated interface with the first base station and the first base station receives the system configuration information. The system configuration information refers to information required for RRC connection establishment, and at least includes synchronization information and system bandwidth information. Of course, the system configuration information may also include other information, which is not limited in the embodiment of the disclosure.

In a possible implementation, the designated signaling is an RRC connection reconfiguration signaling, which is typically used for establishing and reconfiguring a Signaling Radio Bearer 2 (SRB2) and a Data Radio Bearer (DRB). Of course, instead of being the RRC connection configuration signaling, the designated signaling may also be a signaling dedicated for transferring the system configuration information, which is not limited in the embodiments of the disclosure.

In one or more embodiments of the disclosure, when it is detected that the UE experiences a switch of service and when the second base station satisfies requirements for the service switch, the step of generating the designated signaling from the system configuration information of the second base station is performed. The switch of service refers to a change of the UE's service. For example, the UE's data service changes from webpage browsing to video playing. The service switch may need more bandwidth or other resources from the next base station. In that case, the first base station may not have capacity to satisfy requirements for the service switch. If there is a second base station which has capacity to satisfy the requirements for the service switch within the coverage area of the first base station, the first base station may carry the system configuration information of the second base station in the designated signaling and send the signaling to the UE. Thus, the UE may establish an RRC connection with the second base station and perform the desired data service via the second base station after the switch.

It should be noted that the first base station may determine whether it is needed to switch to the second base station based on the UE's service request. The determination may be performed based on the type of the service request or the like, which is not limited in the embodiment of the disclosure.

At step 202, the first base station sends the designated signaling to the UE.

In a possible implementation, the designated signaling is a broadcast message or a unicast message, which is not limited in the disclosure. The designated message may be a unicast message sent to only a certain UE for informing the UE of how to perform RRC connection establishment with the second base station. Alternatively, the designated signaling may be a broadcast message sent to multiple UEs for informing each UE of information required for performing RRC connection establishment with the second base station, so that the UE can acquire the system configuration information locally when it needs to perform RRC connection establishment with the second base station.

At step 203, when receiving the designated signaling sent by the first base station, the UE establishes an RRC connection with the second base station based on the system configuration information of the second base station.

When receiving the designated signaling sent by the first base station and determining to perform base station switching, the UE establishes an RRC connection with the second base station based on the system configuration information of the second base station. The process for establishing an RRC connection with the second base station is similar to the process for establishing an RRC connection with the first base station, and will not be repeated here.

Some embodiments of the disclosure may be implemented based on a novel Long Term Evolution-New Radio (LTE-NR) control plane aggregation network architecture. This novel control plane aggregation network architecture includes the above-described first base station and second base station. The first base station is an LTE base station and the second base station is a 5G base station. Alternatively, the first base station is a 5G base station and the second base station is an LTE base station.

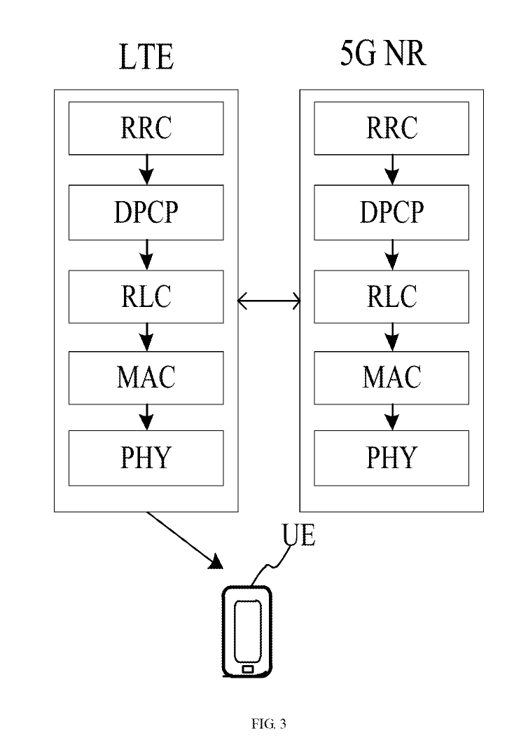

For example, the first base station is an LTE base station, and the second base station is a 5G base station. Referring to FIG. 3, in LTE, the control plane may include an RRC layer, a Packet Data Convergence Protocol (PDCP) layer, a Radio Link Control (RLC) layer, a Media Access Control (MAC) layer, and a Physical (PHY) layer. If Dual Connectivity (DC) or the like is used as the basis of the LTE-NR control plane aggregation network architecture and LTE serves as the anchor, system configuration information of 5G NR may be transmitted to the LTE through a newly defined Xn interface and sent to a UE by the RRC layer of the LTE, and no RRC signaling is generated by the 5G NR.

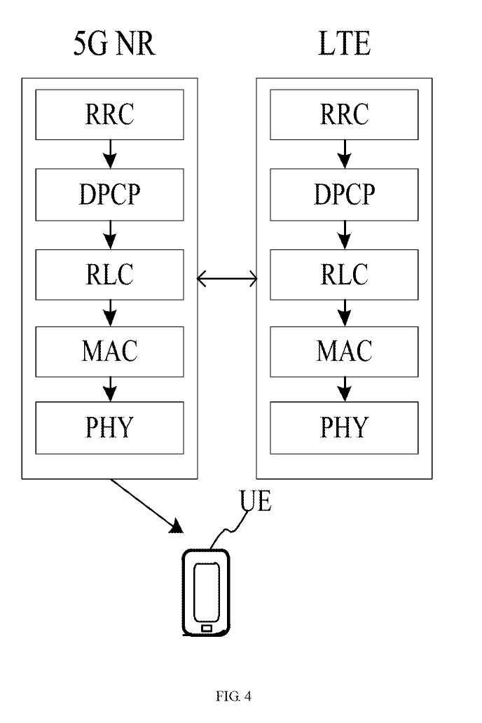

For example, the first base station is a 5G base station, and the second base station is an LTE base station. Referring to FIG. 4, when Dual Connectivity (DC) or the like is used as the basis of the LTE-NR control plane aggregation network architecture and NR serves as the anchor, system configuration information of LTE may be transmitted to the NR through a newly defined Xn interface and sent to a UE by the RRC layer of the NR, and no RRC signaling is generated by the LTE.

The disclosure provides methods so that a UE is unlikely to simultaneously receive RRC signaling from both LTE and 5G NR, thereby reducing the complexity of the UE. Thus, LTE and 5G NR networks can be effectively aggregated on control plane, thereby improving control plane aggregation performance of these two networks.

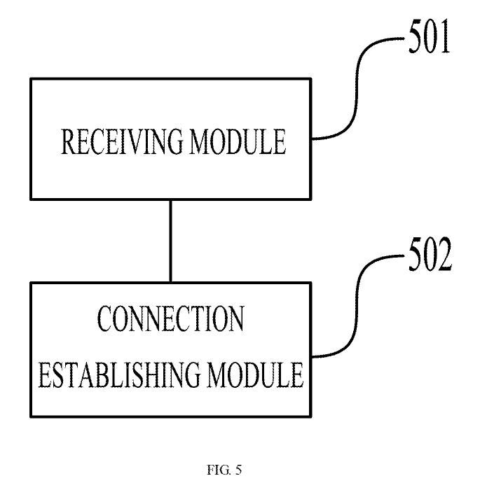

FIG. 5 is a block diagram of a user equipment according to an exemplary embodiment. As shown, the user equipment includes the following modules 501 and 502.

The receiving module 501 is configured to receive a designated signaling sent by a first base station, the designated signaling carrying system configuration information of a second base station.

The connection establishing module 502 is configured to establish an RRC connection with the second base station, based on the system configuration information of the second base station.

In one or more embodiments, the system configuration information of the second base station is sent to the first base station by the second base station through a designated interface.

In one or more possible embodiments, the designated signaling is an RRC connection reconfiguration signaling.

In one or more possible embodiments, the designated signaling is a broadcast message or a unicast message.

In one or more possible embodiments, the system configuration information at least includes synchronization information and system bandwidth information.

In one or more possible embodiments, the first base station is an LTE base station, and the second base station is a 5G base station; or the first base station is a 5G base station, and the second base station is an LTE base station.

Regarding the user equipment in the above embodiments, the specific manners for the individual modules to perform operations have been described in detail in the embodiments of the related methods and will not be elaborated herein.

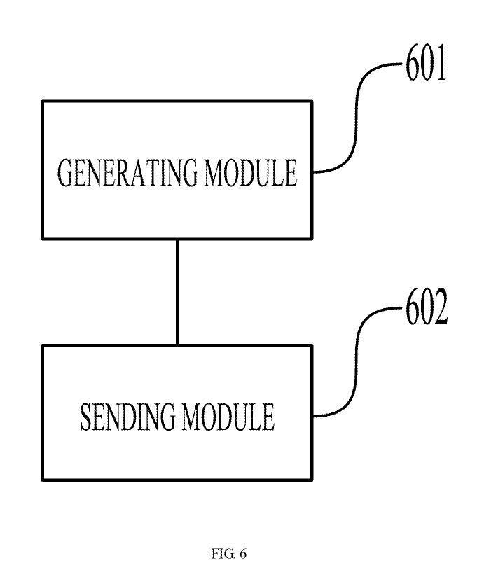

FIG. 6 is a block diagram of a base station according to one or more exemplary embodiments. As shown, the base station includes the following modules 601 and 602.

The generating module 601 is configured to generate a designated signaling from system configuration information of a second base station, the designated signaling carrying the system configuration information of the second bases station.

The sending module 602 is configured to send the designated signaling to a UE, so that the UE establishes an RRC connection based on the system configuration information of the second base station.

In one or more possible embodiments, the base station further comprises: a receiving module configured to receive the system configuration information sent by the second base station, through a designated interface with the second base station.

In one or more possible embodiments, the generating module is configured to: when it is detected that the UE experiences a switch of service and if the second base station satisfies requirements for the service switch, generate the designated signaling from the system configuration information of the second base station.

In one or more possible embodiments, the designated signaling is an RRC connection reconfiguration signaling.

In one or more possible embodiments, the designated signaling is a broadcast message or a unicast message.

In one or more possible embodiments, the system configuration information at least includes synchronization information and system bandwidth information.

In one or more possible embodiments, the base station is an LTE base station, and the second base station is a 5G base station; or the base station is a 5G base station, and the second base station is an LTE base station.

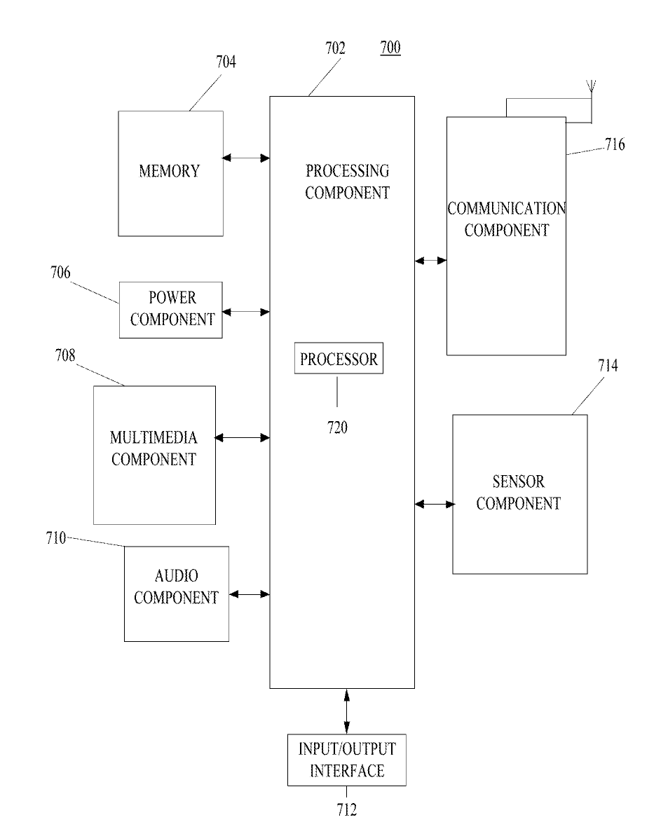

FIG. 7 illustrates a schematic diagram of a user equipment 700 according to one or more exemplary embodiments. For example, the user equipment 700 may be a mobile phone, a computer, a digital broadcast terminal, a messaging device, a gaming console, a tablet device, a medical device, exercise equipment, a personal digital assistant or the like.

Referring to FIG. 7, the user equipment 700 may comprise one or more of the following components: a processing component 702, a memory 704, a power component 706, a multimedia component 708, an audio component 710, an input/output (I/O) interface 712, a sensor component 714 and a communication component 716.

The processing component 702 typically controls overall operations of the user equipment 700, such as the operations associated with display, telephone calls, data communications, camera operations and recording operations. The processing component 702 may include one or more processors 720 to execute instructions to perform all or some of the steps in the above described methods. Moreover, the processing component 702 may include one or more modules which facilitate the interaction between the processing component 702 and other components. For example, the processing component 702 may comprise a multimedia module to facilitate the interaction between the multimedia component 708 and the processing component 702.

The memory 704 is configured to store various types of data to support the operation of the user equipment 700. Examples of such data comprise instructions for any applications or methods operated on the user equipment 700, contact data, phonebook data, messages, pictures, videos, etc. The memory 704 may be implemented by using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 706 provides power to various components of the user equipment 700. The power component 706 may comprise a power management system, one or more power sources, and any other components associated with the generation, management, and distribution of power in the user equipment 700.

The multimedia component 708 comprises a screen providing an output interface between the user equipment 700 and the user. In some embodiments, the screen may comprise a liquid crystal display (LCD) and a touch panel (TP). If the screen comprises the touch panel, the screen may be implemented as a touch screen to receive input signals from the user. The touch panel comprises one or more touch sensors to sense touches, swipes and gestures on the touch panel. The touch sensors may not only sense a boundary of a touch or swipe action, but also sense a period of time and a pressure associated with the touch or swipe action. In some embodiments, the multimedia component 708 includes a front camera and/or a rear camera. The front camera and the rear camera may receive an external multimedia datum while the user equipment 700 is in an operation mode, such as a photographing mode or a video mode. Each of the front camera and the rear camera may be a fixed optical lens system or have focus and optical zoom capability.

The audio component 710 is configured to output and/or input audio signals. For example, the audio component 710 includes a microphone (MIC) configured to receive an external audio signal when the user equipment 700 is in an operation mode, such as a call mode, a recording mode, and a voice recognition mode. The received audio signal may be further stored in the memory 704 or transmitted via the communication component 716. In some embodiments, the audio component 710 further includes a speaker to output audio signals.

The I/O interface 712 provides an interface between the processing component 702 and peripheral interface modules, such as a keyboard, a click wheel, buttons, and the like. The buttons may include, but are not limited to, a home button, a volume button, a starting button, and a locking button.

The sensor component 714 comprises one or more sensors to provide status assessments of various aspects of the user equipment 700. For instance, the sensor component 714 may detect an open/closed status of the user equipment 700, relative positioning of components, e.g., the display and the keypad, of the user equipment 700, a change in position of the user equipment 700 or a component of the user equipment 700, presence or absence of user's contact with the user equipment 700, an orientation or an acceleration/deceleration of the user equipment 700, and a change in temperature of the user equipment 700. The sensor component 714 may include a proximity sensor configured to detect the presence of nearby objects without any physical contact. The sensor component 714 may also include a light sensor, such as a CMOS or CCD image sensor, for use in imaging applications. In some embodiments, the sensor component 714 may also include an accelerometer sensor, a gyroscope sensor, a magnetic sensor, a pressure sensor or a temperature sensor.

The communication component 716 is configured to facilitate communication, wired or wirelessly, between the user equipment 700 and other devices. The user equipment 700 can access a wireless network based on a communication standard, such as WiFi, 2G or 3G; or a combination thereof. In one embodiment, the communication component 716 receives a broadcast signal or broadcast associated information from an external broadcast management system via a broadcast channel. In one embodiment, the communication component 716 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an embodiment, the user equipment 700 may be implemented with one or more circuitries, which include application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components. The user equipment 700 may use the circuitries in combination with the other hardware or software components for performing the above described methods. Each module, sub-module, unit, or sub-unit in the disclosure may be implemented at least partially using the one or more circuitries.

In an embodiment, there is also provided a non-transitory computer-readable storage medium comprising instructions, such as comprised in the memory 704, executable by the processor 720 in the user equipment 700, for performing the above-described methods. For example, the non-transitory computer-readable storage medium may be a ROM, a RAM, a CD-ROM, a magnetic tape, a floppy disc, an optical data storage device or the like. Further, each module or sub-module may include non-transitory memory (shared, dedicated, or group) that stores code or instructions that can be executed by one or more processors. The module or sub-module may take the form of a packaged functional hardware unit designed for use with other components, a portion of a program code (e.g., software or firmware) executable by the processor 720, one or more circuitries that usually perform a particular function of related functions, or a self-contained hardware or software component that interfaces with a larger system, for example.

The non-transitory computer-readable storage medium has stored therein instructions that, when executed by a processor of the user equipment 700, cause the user equipment 700 to perform one of the above RRC connection establishing methods.

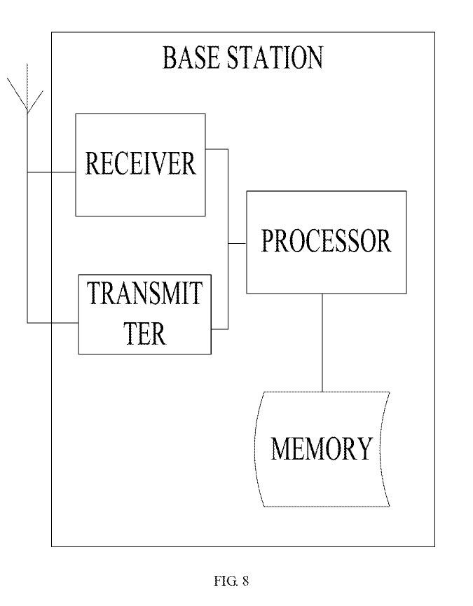

FIG. 8 is a schematic structural diagram of a base station according to an exemplary embodiment. As shown, the base station includes a transmitter, a receiver, a memory and a processor connected with the transmitter, the receiver and the memory. Of course, the base station may also include common components, such as an antenna, a baseband processing component, an intermediate frequency and radio frequency processing component, which is not limited in the embodiment of the disclosure.

The base station is configured to perform an RRC connection establishing method at base station side according to the embodiment shown in FIG. 2. The transmitter and the receiver may be implemented as a transceiver. The processor may be a Central Processing Unit (CPU), a microprocessor, a single chip machine or the like.

The terminology used in the present disclosure is for the purpose of describing exemplary embodiments only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” etc. may be used herein to describe various information, the information should not be limited by these terms. These terms are only used to distinguish one category of information from another. For example, without departing from the scope of the present disclosure, first information may be termed as second information; and similarly, second information may also be termed as first information. As used herein, the term “if” may be understood to mean “when” or “upon” or “in response to” depending on the context.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may be combined in any suitable manner.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

1. A method, comprising:
generating, by a first base station, a designated signaling from system configuration information of a second base station, the designated signaling carrying the system configuration information of the second bases station; and
sending, by the first base station, the designated signaling to a User Equipment (UE) so that the UE establishes a Radio Resource Control (RRC) connection based on the system configuration information of the second base station.

2. The method of claim 1, wherein, before generating the designated signaling from the system configuration information of the second base station, the method further comprises:
receiving the system configuration information sent by the second base station, through a designated interface with the second base station.

3. The method of claim 1, wherein when it is detected that the UE experiences a switch of service and when the second base station satisfies requirements for the service switch, generating the designated signaling from the system configuration information of the second base station.

4. The method of claim 1, wherein the designated signaling is an RRC connection reconfiguration signaling.

5. The method of claim 1, wherein the designated signaling is a broadcast message or a unicast message.

6. The method of claim 1, wherein the system configuration information at least includes synchronization information and system bandwidth information.

7. The method of claim 1, wherein one of the first base station and the second base station is a Long-Term Evolution (LTE) base station, and the other of the first base station and the second base station is a 5G base station.

8. A base station, comprising:
a processor; and
a memory configured to store instructions executable by the processor,
wherein the processor is configured to:
generate a designated signaling from system configuration information of a second base station, the designated signaling carrying the system configuration information of the second bases station; and
send the designated signaling to a User Equipment (UE) so that the UE establishes a Radio Resource Control (RRC) connection based on the system configuration information of the second base station.

9. The base station of claim 8, wherein the processor is further configured to:
receive the system configuration information sent by the second base station, through a designated interface with the second base station before generating the designated signaling.

10. The base station of claim 8, wherein the processor is further configured to:
when it is detected that the UE experiences a switch of service and when the second base station satisfies requirements for the service switch, generate the designated signaling from the system configuration information of the second base station.

11. The base station of claim 8, wherein the designated signaling is an RRC connection reconfiguration signaling.

12. The base station of claim 8, wherein the designated signaling is a broadcast message or a unicast message.

13. The base station of claim 8, wherein the system configuration information at least includes synchronization information and system bandwidth information.

14. The base station of claim 8, wherein the base station supports one of an Long-Term Evolution (LTE) standard or a 5G standard.

15. A non-transitory computer-readable storage medium having stored therein instructions that, when executed by a processor of a first base station, causes the first base station to perform acts comprising:
generating a designated signaling from system configuration information of a second base station, the designated signaling carrying the system configuration information of the second bases station; and
sending the designated signaling to a User Equipment(UE) so that the UE establishes a Radio Resource Control (RRC) connection based on the system configuration information of the second base station.

16. The non-transitory computer-readable storage medium of claim 15, wherein, before the designated signaling is generated from the system configuration information of the second base station, the acts further comprise:
receiving the system configuration information sent by the second base station, through a designated interface with the second base station.

17. The non-transitory computer-readable storage medium of claim 15, wherein when it is detected that the UE experiences a switch of service and when the second base station satisfies requirements for the service switch, the designated signaling is generated from the system configuration information of the second base station.

18. The non-transitory computer-readable storage medium of claim 15, wherein the designated signaling is an RRC connection reconfiguration signaling.

19. The non-transitory computer-readable storage medium of claim 15, wherein the designated signaling is a broadcast message or a unicast message.

20. The non-transitory computer-readable storage medium of claim 15, wherein the system configuration information at least includes synchronization information and system bandwidth information.
